(19) United States
(12) Patent Application Publication
(10) Pub. No.: US 2010/0102926 A1
(43) Pub. Date: Apr. 29, 2010

(54) METHODS AND SYSTEMS FOR AD HOC SENSOR NETWORK

(75) Inventors: Bruce Donaldson Grieve, Manchester (GB); Paul Wright, Manchester (GB); Peter Green, Manchester (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/530,813

(22) PCT Filed: Mar. 13, 2008
(86) PCT No.: PCT/GB08/00872

§ 371 Date: Sep. 11, 2009

Related U.S. Application Data
(60) Provisional application No. 60/894,596, filed on Mar. 13, 2007.

(51) Int. Cl. G05B 19/00

(52) U.S. Cl. 340/5.1

(57) ABSTRACT

Methods and systems are provided for controlling a first node in an ad hoc network including network nodes, at least some of which are asynchronous nodes having a dormancy period and a non-dormancy period. The method may include activating a non-dormant-state after a predetermined period of dormancy. The method may also include storing status information at the first node, said status information describing at least one condition of the first node. The method may also include receiving, during the non-dormant-state, status information about a second, non dormant node. The method may also include storing the received status information at the first node. The method may also include communicating the stored status information of the first node and the second node and reactivating the dormant-state.

The present disclosure relates generally to systems and methods for networks including a plurality of sensor nodes.

Termites invade houses in their search for cellulosic foodstuffs. The damage to properties in the United States is put at about $1 billion per annum. Various methods have been used to protect buildings from being infested with termites, and many more methods used to rid the buildings of termites once infested.

Some recent methods of termite control involve baiting the termite colony with stations housing a termite toxicant. Known bait stations include above-ground stations useful for placement on termite mud tubes and below-ground stations having a tubular outer housing that is implanted in the ground with an upper end of the housing substantially flush with the ground level to avoid being damaged by a lawn mower. A tubular bait cartridge containing a quantity of bait material (with or without any toxic active ingredient) is inserted into the outer housing.

In one practice, a baiting system comprising a plurality of stations is installed underground around the perimeter of a building. Individual stations are installed in prime termite foraging areas as monitoring devices to get “hits” (termites and feeding damage). When termite workers are found in one or more stations, a toxic bait material is substituted for the monitoring bait so that the termite workers will carry it back to the termite nest and kill a portion of the exposed colony. However, this approach does not work if the termites completely consume the monitoring bait and abandon a particular station before the hit is discovered and the station is baited with toxicant. This problem can be mitigated by increasing the frequency of manual inspections for individual bait stations. Moreover, the bait element of each station must periodically be removed and inspected for signs of termite activity.

The drawback to this approach is a substantial increase in the overall cost of monitoring and servicing of the baiting system and a reduction in its overall effectiveness. Accordingly, there exists a need for a more efficient, cost-effective, and robust remote monitoring of bait stations. The disclosed methods and systems for implementing a sensor network are directed to overcoming one or more of the problems set forth above.

In some embodiments, methods and systems are provided for controlling a first node in an ad hoc network including a plurality of network nodes, at least some of which being asynchronous nodes having a dormancy period and a non-dormancy period. The method may include activating a non-dormant-state after a predetermined period of dormancy. The method may also include storing status information at the first node, said status information describing at least one condition of the first node. The method may also include receiving, during the non-dormant-state, status information about a second, non dormant node. The method may also include storing the received status information at the first node. The method may also include communicating the stored status information of the first node and the second node and reactivating the dormant-state.

In other embodiments, methods and systems are provided for controlling a termite sensor node in an ad hoc network including a plurality of termite sensor nodes, each node operating asynchronously. The method may include activating a non-dormant-state after a predetermined period of dormancy. The method may also include storing detection information at the node, said detection information including a Boolean value indicating whether or not a termite detector in the node has been triggered. The method may also include receiving, during the non-dormant-state, detection information about another, non-dormant termite sensor node. The method may also include storing the received status information at the node. The method also may include communicating the stored detection information of the first node and the at least one other node and reactivating the dormant-state.

In further embodiments, methods and systems are provided for controlling a termite sensor node in an ad hoc network including a plurality of termite sensor nodes, each node operating asynchronously. The method may include activating a non-dormant-state after a predetermined period of dormancy. The method may also include storing, at the node, status information indicating whether or not a termite detector in the node has been triggered. The method also may include storing, at the node, information indicating whether or not the node has communicated the stored status information to another non-dormant one of the plurality of termite sensor nodes included in the plurality of nodes. The method also may include communicating the stored information and reactivating the dormant-state.

In some embodiments, a method is provided for controlling a node in an ad hoc network including a plurality of network nodes, each node operating asynchronously from the other nodes. The method may include activating a non-dormant-state after a predetermined period of dormancy. The method also may include activating a standby-state during a predetermined portion of the dormant-state if no communication is received from another node, wherein the standby-state precedes or succeeds the non-dormant-state and is interrupted upon receipt of a communication from another node.

In additional embodiments, a method is provided for servicing a sensor node within an ad hoc network including a plurality of sensor nodes. The method may include

activating a non-dormant-state after a predetermined period of dormancy. The method also may include receiving status information from a second, non-dormant node during the non-dormant-state. And, the method also may include activating, based on the status information, a service-state for a predetermined period of time.

In some embodiments, a scaleable wireless sensor network is provided. The system may include a plurality of sensor nodes operable to detect at least one pest condition. The system also may include at least one local area network using an ad hoc protocol that asynchronously connects said plurality of sensor nodes. The system also may include a gateway node wirelessly connected to said at least one wireless local area network configured to log data from one or more of said sensor nodes. And, the system also may include an operations center operationally connected to said gateway node using a wide area network protocol.

In other embodiments, a method for installing a sensor network is provided. The method may include installing a first network node at a first location. The method also may include broadcasting a beacon signal from the gateway node and the first network node. The method may include identifying an installation location for a second node based on the strength of the beacon signal. The method may include installing the second node at the second location. The method may include retransmitting the beacon signal from the first, second and gateway nodes. The method may include identifying an installation location for a third node based on the strength of the retransmitted beacon signal. And, the method may include installing the third node at the third location, wherein the location is determined using a handheld service node.

### BRIEF DESCRIPTION OF THE DRAWINGS

FIG. 1 is a block diagram illustrating an exemplary system, consistent with at least one of the disclosed embodiments;

FIGS. 2A and 2B are block diagrams illustrating an exemplary network node, consistent with at least one of the disclosed embodiments;

FIGS. 3A and 3B are block diagrams illustrating an exemplary network node, to consistent with at least one of the disclosed embodiments;

FIG. 4 is a state diagram illustrating exemplary network node states, consistent with at least one of the disclosed embodiments;

FIG. 5 is a block diagram illustrating exemplary data, consistent with at least one of the disclosed embodiments;

FIGS. 6A-6E are block diagrams illustrating exemplary network node transmissions, consistent with at least one of the disclosed embodiments;

FIGS. 7A and 7B are flowcharts, illustrating an exemplary method for a sensor network, consistent with at least one of the disclosed embodiments;

FIG. 8 is a flowchart, illustrating an exemplary method for realigning a sensor network, consistent with at least one of the disclosed embodiments;

FIG. 9 is a flowchart, illustrating an exemplary method for installing a sensor network, consistent with at least one of the disclosed embodiments; and

FIG. 10 is a flowchart, illustrating an exemplary method for servicing a sensor network, consistent with at least one of the disclosed embodiment.

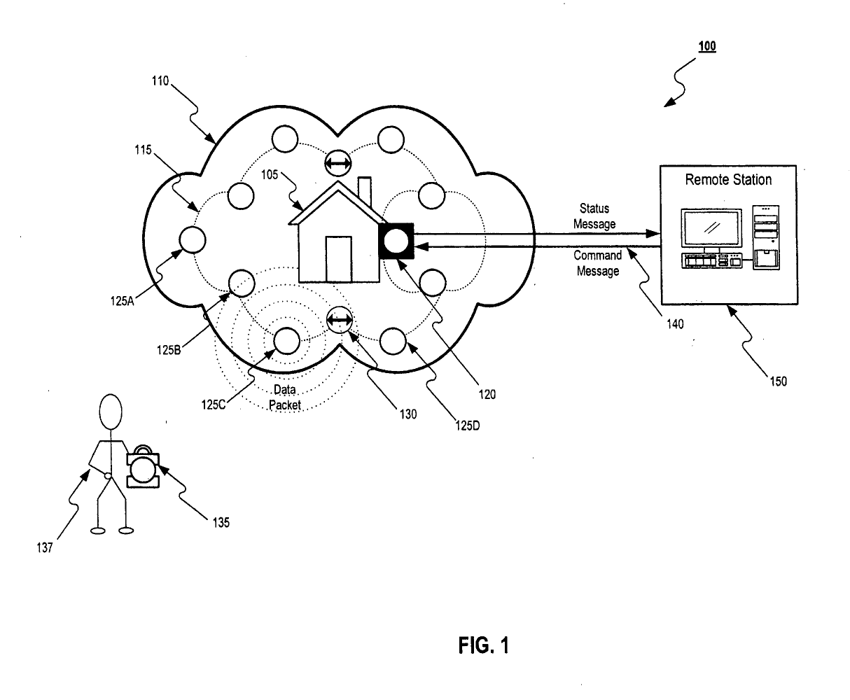

FIG. 1 is a block diagram illustrating an exemplary system 100 that may benefit from some embodiments of the present disclosure. As shown in FIG. 1, system 100 may include a structure 105, a location 110, a sensor network 115, a communication channel 140, and a remote station 150. Location 110 may be any region having natural or arbitrary boundaries. Exemplary location 110 may be an area of land around a structure 105, such as a residential building. However, location 110 may be any space having characteristics that may be monitored in accordance with embodiments consistent with this disclosure.

Sensor network 115 may be an ad hoc network having a plurality of network nodes, including exemplary nodes 120-130, that may individually and/or collectively monitor some or all portions of location 110. Consistent with some embodiments, sensor network 115 may provide status information to remote station 115 via communication network 140. Due to the ad hoc nature of sensor network 115, a particular network node is not guaranteed to be available at a time when another node attempts to communicate. Nevertheless, the operational states of the network nodes may be aligned such that the nodes have overlapping communication cycles during which some or all of nodes 120-130 in sensor network 115 exchange status information before entering a dormant phase. Sensor network 115 may be configured in any topology, including a line, a ring, a star, a bus, a tree, a mesh, or a perforated mesh. FIG. 1, for instance, shows sensor network 115 having a perforated mesh topology, which may be advantageous in embodiments in which sensor network 115 encompasses irregular terrain, objects (e.g., structure 105), or other obstacles in and around location 110.

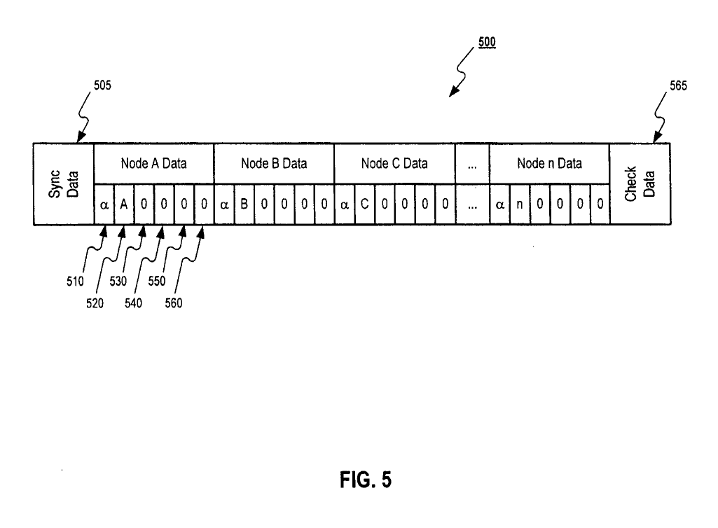

Each network node 120-130 in sensor network 115 may be configured to receive and store status information included within one or more data packets 500 broadcast by another one of the network nodes (See FIG. 5). Data packet 500 may be a set of computer-readable data including data fields 510 that contain information indicative of the status of one or more nodes included in sensor network 115. Periodically the network nodes may communicate data packets including the status information about other nodes stored in the respective node. Communication between network nodes 120-130 may be wireless or over direct connections (e.g., wires or fiber optic lines). In addition, nodes 120-130 may communicate by broadcasting the status information for receipt by any node in broadcast range, or the nodes may transmit the information specifically to one or more other nodes in sensor network 115. For instance, consistent with some embodiments, sensor node 125A may wirelessly broadcast a data packet including status information about sensor node 125A and, in combination, status information received from another sensor node 125B in range. In this manner, the status of each node in sensor network 115 may be propagated to all other nodes 120-130 such that each may store a collection of information about the status of all nodes in network 115. In one embodiment, this status information is stored in any particular node only during an active communication cycle. In another embodiment, status information concerning multiple communication cycles is stored in one or more network nodes. In another embodiment, status information from multiple cycles is stored in base node 120. In yet another embodiment, status information from multiple communication cycles is stored in a remote station 150.

As illustrated in FIG. 1, sensor network 115 may include a plurality of network nodes including base node 120, sensor nodes 125, and relay nodes 130. In addition, a service node 135 may be used to assist a technician 137 in installing and servicing sensor network 115. As described in greater detail below, base node 120 may be a device for receiving status information from each of the other network nodes 125-130 and exchanging information with remote station 150 over communication link 140. Status information received from sensor network 115 may be received at base node 120 for communication to remote station 150 over communication network 140 in a status message. In some embodiments, the status information received by base node 120 may stored in a database associated with base node 120 and the stored status information may be periodically communicate to remote station 150 combined within one or more status messages. In other embodiments, base node 120 may communicate each data packet received from sensor network 115 to remote station 150 in an separate status message. Furthermore, base node 120 may receive command information from remote station 150 and communicate the information to sensor network 115.

Sensor nodes 125 may be network devices for collecting information and broadcasting the information to other nodes in sensor network 115. The information can include data relating to one or more parameters being sensed or measured by one or more sensors connected to the node. To minimize energy consumption, sensor nodes 125 may be configured to cycle through states of dormancy and non-dormancy. During non-dormant-states, sensor nodes 125 may receive and/or broadcast information describing the status of sensor 125. During dormant-states, however, sensor nodes 125 may minimize activities, such as communication and data processing. By remaining in a dormant-state a majority of the time, sensor nodes 125 and relay nodes 130 may conserve energy, thereby reducing the amount of servicing to, for instance, replace power sources (e.g., batteries), and thereby reducing the cost of maintaining sensor network 115.

A relay node 130 may be a network device for relaying information received from another one of the nodes in sensor network 115. In some embodiments, relay node 130 may include components similar to sensor nodes 125, except for excluding a sensor. In other embodiments, a relay node will be identical to a sensor node, but will be positioned in such a way as to connect portions of the network otherwise isolated from each other (outside broadcast range). When a data packet 500 is received from another node, relay node 130 may store the information 510-560 in the received packets and, subsequently, broadcast a data packet containing the stored data. Status data about relay nodes 130 may, in some embodiments, be stored as null values. In other embodiments, however, relay nodes 130 do not store status information and, instead, rebroadcast each individual status packet received from another node immediately upon receipt.

Service node 135 may be a device for deploying and servicing sensor network 115. Service node 135 may be configured with components similar to sensor node 125, but service node 135 may be adapted for being man-portable and include one or more human-user interfaces allowing technician 137 to interact with the device. Technician 137, for example, may employ service node 135 to ensure that network nodes 120-130 are installed within broadcast range of each other. Additionally, technician 137 may use service node 135 to locate sensor nodes 125 during a service visit.

As further shown in FIG. 1, base node 120 may transmit status messages to remote station 150 over communication channel 140 and/or receive command messages from remote station 150. A status message may include information about network nodes received by base node 120 from sensor network 115. Status information about sensor network 115 may include information indicative of the status of one or more network nodes 120-130 in sensor network 115. For instance, status information of sensor node 125 may indicate whether a node is dormant; whether a node is low on battery power; or whether a particular sensor has been triggered.

Command messages may include instructions for network 115 from remote station 150 and may include commands for network nodes 120-130. For instance, consistent with some embodiments, a pest control provider monitoring sensor network 115 using remote station 150 may determine that a service visit is necessary. Prior to dispatching technician 137 for a service visit, the pest control provider may issue a service-state command to sensor network 115 via remote station 150. The command message then may be received by base node 120, from which the command to initiate a service-state is propagated to each of the non-dormant nodes during a communication-cycle.

The status messages and command messages may be any type file, document, message, or record. For instance, these messages may be a set of computer-readable data, an electronic mail, facsimile message, simple-message service (“SMS”), or message or multimedia message service (“MMS”) message. In addition, these messages may comprise a document such as a letter, a text file, a flat file, database record, a spreadsheet, or a data file. Information in the messages generally may be text, but also may include other content such as sound, video, pictures, or other audiovisual information.

Communications channel 140 may be any channel used for the communication of status information between sensor network 115 and remote station 150. Communications channel 140 may be a shared, public, private, or peer-to-peer network, encompassing any wide or local area network, such as an extranet, an intranet, the Internet, a Local Area Network (LAN), a Wide Area Network (WAN), a public switched telephone network (PSTN), an Integrated Services Digital Network (ISDN), radio links, a cable television network, a satellite television network, a terrestrial wireless network, or any other form of wired or wireless communication network. Further, communications channel 140 may be compatible with any type of communications protocol used by the components of system 100 to exchange data, such as the Ethernet protocol, ATM protocol, Transmission Control/Internet Protocol (TCP/IP), Hypertext Transfer Protocol (HTTP), Hypertext Transfer Protocol Secure (HTTPS), Real-time Transport Protocol (RTP), Real Time Streaming Protocol (RTSP), Global System for Mobile Communication (GSM) and Code Division Multiple Access (CDMA) wireless formats, Wireless Application Protocol (WAP), high bandwidth wireless protocols (e.g., EV-DO, WCDMA), or peer-to-peer protocols. The particular composition and protocol of communications channel 140 is not critical as long as it allows for communication between base node 120 and remote station 150.

Remote station 150 may be a data processing system located remotely from sensor network 115 and adapted to exchange status messages and command messages with base node 120 over communication channel 140. Remote station 150 may be one or more computer systems including, for example, a personal computer, minicomputer, microprocessor, workstation, mainframe, mobile intelligent terminal or similar computing platform typically employed in the art. Additionally, remote station 150 may have components typical of such computing systems including, for example, a processor, memory, and data storage devices. In some embodiments, remote station 150 may be web server for providing status information to users over a network, such as the Internet. For instance, remote station 150 enables users at remote computers (not shown) to download status information about sensor network 115 over the Internet.

Further, FIG. 1 illustrates the flow of information in system 100. One or more of network nodes 120-130 may communicate with other ones of network nodes 120-130 in sensor network 115. Data packets [500] communicated by one of nodes 120-130 may pass in any direction around sensor network 115. As illustrated, in some embodiments, network nodes 120-130 may communicate wirelessly. Because each node 120-130 of sensor network 115 may have a limited communication range, the path of information flow may depend on the topology of nodes in sensor network 115. Accordingly, nodes 120-130 in sensor network 115 are arranged such that each node is within communication range of at least one other node. As such, nodes 120-130 may exchange information via any of a plurality of possible communication paths. For instance, in sensor network 115 having a perforated mesh topology illustrated in FIG. 1, base node 120 may receive information from sensor node 125A that has traveled either clockwise or counter-clockwise around sensor network 115.

By way of example, FIG. 1 illustrates sensor nodes 125A, 125B, 125C, and 125D. Because, the broadcast range of sensor node 125C overlaps the location of sensor node 125B, sensor node 125C may exchange information directly with sensor node 125B. In addition, although node 125C is not within direct range of sensor node 125A, information from sensor node 125A may be indirectly received by node 125C (and vice versa) via sensor node 125B. In some instances, two nodes may be outside broadcast range. For example, sensor node 125D may not be within range of sensor node 125C. However, to bridge the gap between nodes, sensor network 115 may include one or more relay nodes 130.

Consistent with embodiments disclosed herein, an exemplary location 110* may be a residential property including structure 105, and sensor network 115 may include sensor nodes 125 having sensors for detecting the presence of pests in the property. Using information received from sensor nodes 125, base node 120 may transmit pest detection information to remote station 150. A pest control provider at a remote computer (not shown) may retrieve a web page or the like from remote station 150 including status information about one or more locations 110. Using the information about sensor network 115 presented in the web page, the pest control provider may determine whether pest activity has been detected by a particular sensor node 125 in sensor network 115 at location 110. In addition, the pest control provider may determine whether service issues, such as a node with low battery power, exist in sensor network 115. Based on the status information, the pest control provider may determine whether or not a service visit to location 110 is necessary. If so, using remote station 150 to issue a command message to sensor network 115, the pest control provider may place sensor network 115 in a service mode in advance of the visit by technician 137 to facilitate locating network nodes using service unit 135.

Consistent with embodiments disclosed herein, sensor nodes 125 in network 115 may be located substantially underground and broadcast data packets 500 from an above-ground antenna. When the sensor nodes 125 are placed in the ground, a small portion of each of the sensor nodes 125 may protrude above ground level, a feature which increases environmental robustness and even permits lawn-mowers to pass over unhindered, but which reduces a node's broadcast range and affecting the ability of the transmissions to propagate between nodes. To overcome such issues, the in-ground sensor nodes 125 can be equipped with antennas (such as an F-type antenna) which directs most of the broadcasted signal above the plane of the ground surface. This can be combined with frequency diversity (such as FHSS), space diversity (multiple nodes=multiple receiving antennas) and message redundancy (same data packet rebroadcast multiple times on each of multiple frequencies).

Sensor nodes 125 may be arranged in a substantially flat plane in which a particular sensor node 125 may have a line-of-sight with some or all of the other sensor nodes 125. In some instances, the plane may be broken by terrain, a structure, an object, or other obstacle that may block the line-of-sight between sensor nodes, 125. To circumvent the obstacle, a relay node 130 may be positioned apart from the plane to enable communication between the nodes. For example, consistent with embodiments in which sensor nodes 125 may be located substantially underground at location 110, the ground may define a ground plane in which the above-ground antenna of sensor nodes 125 have a line-of-sight to other ones of sensor nodes 125 above the ground plane. If the ground plane is broken by an obstacle, such as utility transformer, sensor nodes 125C and 125D may have no direct communication path or may be positioned outside communication range. In such circumstances, relay node 130 may be installed above the ground plane to enable communication between sensor nodes 125C and 125D in spite of the obstacle.

Moreover, sensor nodes 125 may relay status information through other nodes of the sensor network 115 to base node 120, which may be located within the residence and operate using the residence's power supply. Base unit 120 may store all sensor information captured by sensor nodes 125. Accordingly, if a pest sensor in sensor node 125A is triggered, for instance, the resulting data packet including status information indicating the detection may be propagated to each of the nodes in sensor network 115, including base node 120. Base node 120 may then transmit a status message including sensor node 125A's detection information, to remote station 150, where the information may be communicated to a pest control provider.

FIG. 1 illustrates a system 100 that includes a single sensor network 115 arranged in a ring around structure 105 and including a single base station 120, several sensor nodes 125, and two relay nodes 130. However, as is readily apparent, other embodiments of system 100 may include a plurality of adjacent or overlapping sensor networks having different shapes and numbers of nodes. Furthermore, although exemplary sensor network 115 is arranged in a ring, one of ordinary skill in the art will recognize that array 115 may be arranged in any shape or pattern (e.g., linear, rectangular, box, grid) or utilize any variety or combination of network topologies including fully connected, ring, mesh, perforated mesh, star, line, tree or bus depending on the shape of a particular location and/or application. In one embodiment, the sensor network is employed in a perforated mesh topology around structure 105.

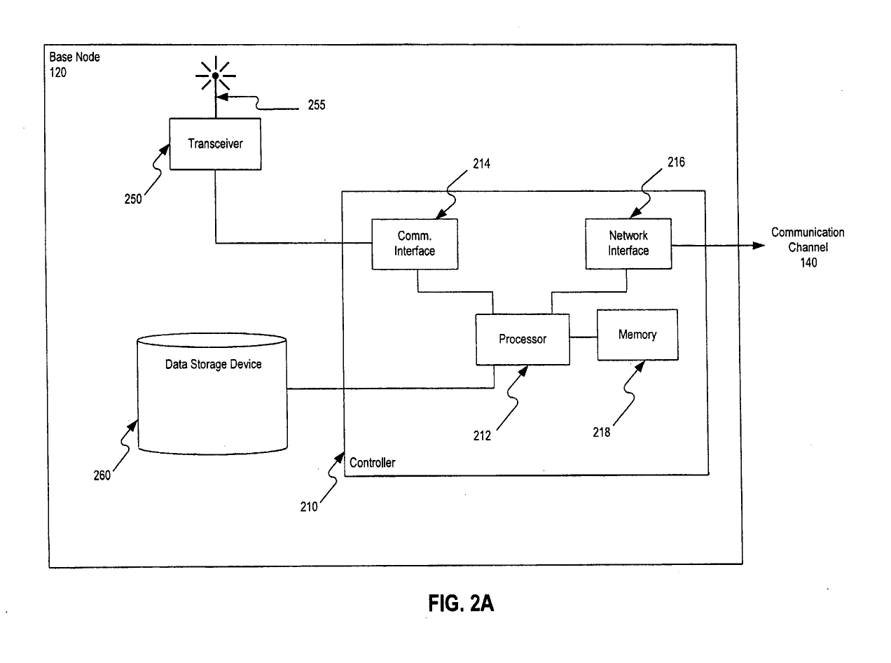

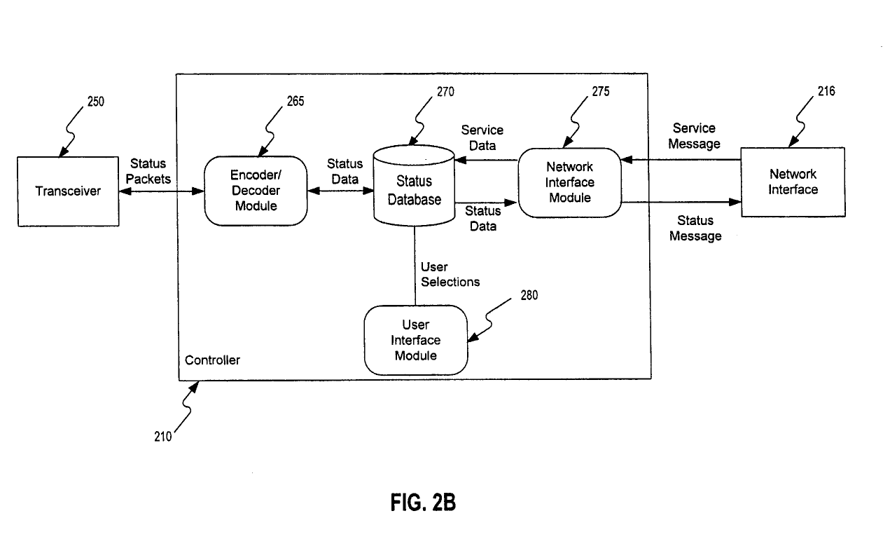

FIGS. 2A and 2B are block diagrams illustrating an exemplary network node, consistent with the disclosed embodiments. Base node 120 may be configured to receive remote data transmissions from the various stand-alone wireless sensor nodes 125 and relay nodes 130. In addition, base node 120 may be adapted to store received status information, convert the status information into a status message (e.g., into TCP/IP format), and transmit the status message via communication channel 140 (e.g., a WAN) to remote station 150.

Base node 120 may include, for example, an embedded system, a personal computer, a minicomputer, a microprocessor, a workstation, a mainframe, or similar computing platform typically employed in the art and may include components typical of such system. As shown in FIG. 2A, base node 120 may include a controller 210, as well as typical user input/output devices and other peripherals. Base node 120 also may include a transceiver 250, antenna 255, and a data storage device 260 for communicating with sensor network 115.

Controller 210 may be one or more processing devices adapted to execute computer instructions stored in one or more memory devices to provide functions and features such as disclosed herein. Controller 210 may include a processor 212, a communications interface 214, a network interface 216 and a memory 218. Processor 212 provides control and processing functions for base node 120 by processing instructions and data stored in memory 218. Processor 212 may be any conventional controller such as off-the-shelf microprocessor, or an application-specific integrated circuit specifically adapted for a base node 120.

Communications interface 214 provides one or more interfaces for transmitting and/or receiving data into processor 212 from external devices, including transceiver 250. Communications interface 214 may be, for example, a serial port (e.g., RS-232, RS-422, universal serial bus (USB), IEEE-1394), parallel port (e.g., IEEE 1284), or wireless port (e.g., infrared, ultraviolet, or radio-frequency transceiver). In some embodiments, signals and/or data from transceiver 250 may be received by communications interface 214 and translated into data suitable for processor 212.

In another embodiment, base node 120 may include components similar to sensor nodes 125, except for excluding a sensor. In one embodiment, base node 120 comprises a personal computer containing a transceiver 250 based on a system-on-chip (SoC) including a microprocessor, a memory and a wireless transceiver operable to wirelessly interface with the sensor nodes 125-130 in the network 115. The transceiver/SoC 250 may be connected to a second microprocessor 212 and a permanent data storage device 260 via, for example, a serial interface, or the like.

Network interface 216 may be any device for sending and receiving data between processor 212 and network communications channel 140. Network interface 216 may, in addition, modulate and/or demodulate data messages into signals for transmission over communications channel 140 data channels (over cables, telephone lines or wirelessly). Further, network interface 216 may support any telecommunications or data network including, for example, Ethernet, WiFi (Wireless-Fidelity), WiMax (World Interoperability for Microwave Access), token ring, ATM (Asynchronous Transfer Mode), DSL (Digital Subscriber Line), or ISDN (Integrated services Digital Network). Alternatively, network interface 216 may be an external network interface connected to controller 210 though communications interface 214.

Memory 218 may be one or more memory devices that store data, operating system and application instructions that, when executed by processor 212, perform the processes described herein. Memory 218 may include semiconductor and magnetic memories such as random access memory (RAM), read-only memory (ROM), electronically erasable programmable ROM (EEPROM), flash memory, optical disks, magnetic disks, etc.

Transceiver 250 and antenna 255 may be adapted to broadcast and receive transmissions with one or more of network nodes 125-130. Transceiver 250 may be a radio-frequency transceiver. Consistent with embodiments of the present disclosure and, as noted above, transceiver 250 may be a Chipcon CC2510 microcontroller/RF transceiver provided by Texas Instruments, Inc. of Dallas, Tex., and antenna 255 may be an inverted F-type antenna. Transceiver 250 may transmit and receive data using a variety of techniques, including Direct Sequence Spread Spectrum (DSSS) or Frequency Hopping Spread Spectrum (FHSS).

Data storage device 260 may be associated with base node 120 for storing software and data consistent with the disclosed embodiments. Data storage device 260 may be implemented with a variety of components or subsystems including, for example, a magnetic disk drive, an optical disk drive, a flash memory, or other devices capable of storing information.

FIG. 2B illustrates a functional block diagram of exemplary base node 120. Controller 210 may execute software processes adapted to exchange information between network nodes 125 and 130 and remote station 150. In addition to an operating system and/or software applications known in the art, controller 210 may execute an encoder/decoder module 265, status database 270, network interface module 275, and user interface module 280.

Encoder/decoder module 265 may be a software module containing instructions executable by processor 212 to encode and/or decode data packets 500 received by transceiver 250 via antenna 255. Encoder/decoder module 265 may decode data packets 500 broadcast by other nodes of sensor network 115 and received by transceiver 250 via antenna 255. In addition, encoder/decoder module 265 may encode data packets including data fields that contain information received from other nodes of sensor network 115, as well as command data received from remote station 150. As illustrated in FIG. 2B, when a data packet containing status data and/or command data is received, this data may be stored in status database 270 along with data previously received from sensor network 115.

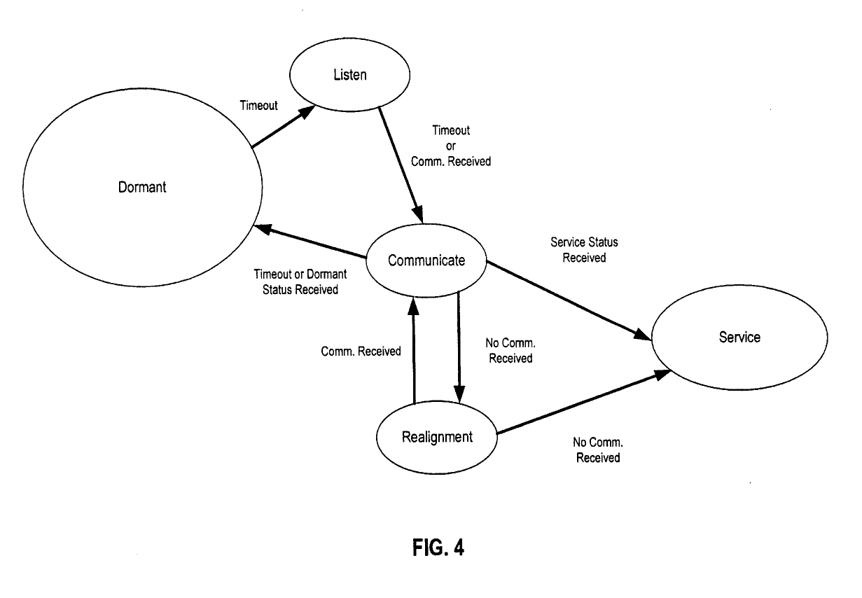

Status database 270 may be a database for storing, querying, and retrieving status data about sensor network 115. As described in more detail below with respect to FIG. 4, status data associated with nodes 120-130 of sensor network 115, including a node's state, communication status, power status, and sensor status. Status database 270 may include an entry corresponding to each node included in sensor network 115. Consistent with some embodiments, sensor network 115 may be configured to include a predetermined number of network nodes (e.g., 40 nodes) and status database 270 may include entries corresponding the to predetermined number, which may be more than the actual number of nodes in sensor network 115. Entries in status database 270 may correspond to information generated during a single communicate cycle, or, in other embodiments, over more than one communicate cycle. In accordance with some embodiments, status database 270 may be implemented as a mySQL database; an Open Source database engine implementing the Structured Query Language.

Because status database 270 stores all communications from the sensor network in data storage device 260, a history of the sensor network may be examined locally, through the base node 120, or remotely, through remote station 150. Use of status database 270, even for temporary holding of data, allows the base node 120 to experience an interruption in power between receipt of data from the sensor network and upstream reporting of those data with only a marginal risk of data loss. In another embodiment, status database 270 is located at a remote station 150 and the data storage device 260 only contains network information relating to the most recent communications cycle.

Network interface module 275 may be computer-executable instructions and potentially also data that, when executed by controller 210, translates data sent and received from communications channel 140. Network interface module 275 may exchange data with at least status database 270, and network interface 216. When sending status messages to remote station 150, network interface module 275 may receive status information from status database 270 and translate the information into a format for transmission over communications channel 140 by network interface 216 in accordance with communications protocol (such as those mentioned previously).

In addition, a user interface module 280 may provide a man-machine interface enabling an individual user to interact with base node 120. For instance, via user interface module 280, using typical input/output devices, a technician 137 may access status database 270 and view status data entries in status database 270 of nodes included in sensor network 115.

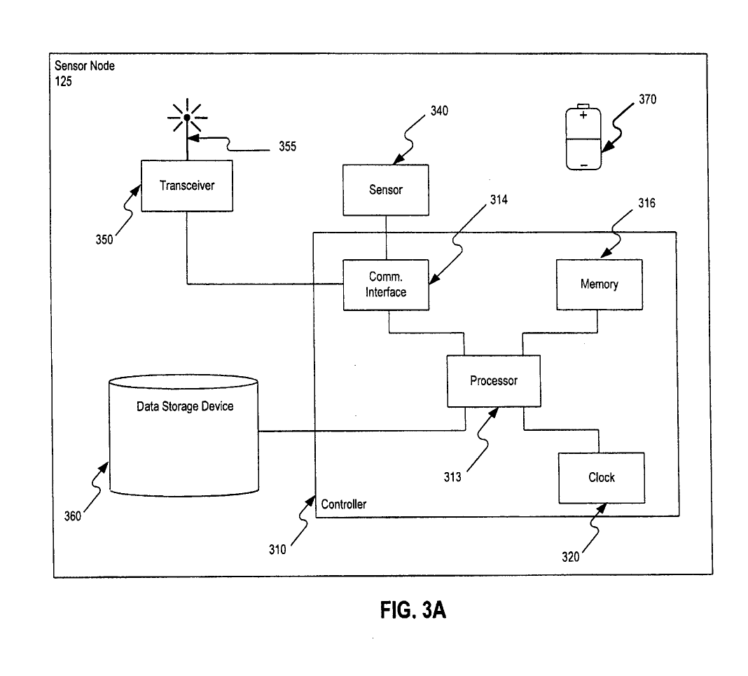

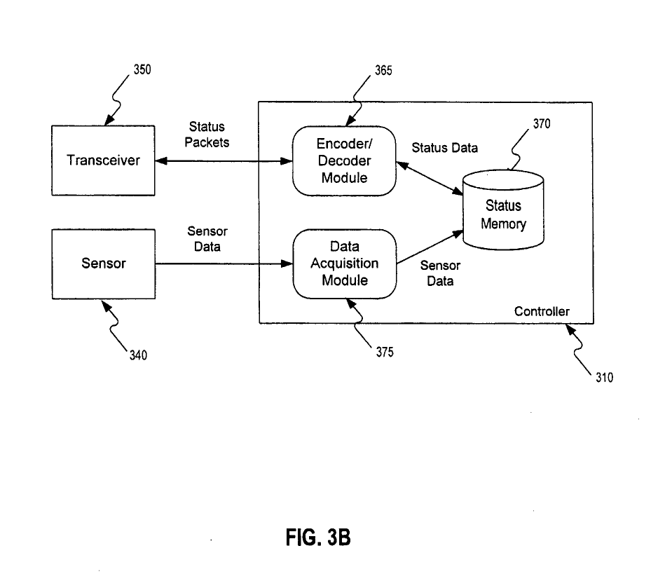

FIGS. 3A and 3B are block diagrams illustrating an exemplary sensor node 125, consistent with the disclosed embodiments. Sensor node 125, may be a wireless device configured to broadcast, receive and store status information indicating the status of the nodes in sensor network 115, including whether or not a sensor node 125 has detected a condition or event in location 110. As shown in FIG. 3A, sensor node 125 may include controller 310, sensor 340 transceiver 350, and antenna 355, data storage device 360, and power supply 370.

Controller 310 may be one or more processing devices adapted to execute computer instructions stored in one or more memory devices to provide functions and features such as disclosed herein. Controller 310 may include a processor 313, a communications interface 314, a memory 316, and a clock 320. In one embodiment, the controller may be a Chipcon CC2510 microcontroller/RF transceiver which is connected to sensor 340, antenna 355, and/or data storage device 360.

Processor 313 provides control and processing functions for sensor node 125 by processing instructions and data stored in memory 316. Processor 313 may be any conventional controller such as off-the-shelf microprocessor, or an application-specific integrated circuit specifically adapted for a sensor node 125.

Communications interface 314 provides one or more interfaces for transmitting and/or receiving data into processor 313 from external devices, including transceiver 350. Communications interface 314 may be, for example, a serial port (e.g., RS-233, RS-422, universal serial bus (USB), IEEE-1394), parallel port (e.g., IEEE 1384), or wireless port (e.g., infrared, ultraviolet, or radio-frequency transceiver). In some embodiments, signals and/or data from sensor 340 and transceiver 350 may be received by communications interface 314 and translated into data suitable for processor 313.

Memory 316 may be one or more memory devices that store data, operating system and application instructions that, when executed by processor 313, perform the processes described herein. Memory 316 may include semiconductor and magnetic memories such as random access memory (RAM), read-only memory (ROM), electronically erasable programmable ROM (EEPROM), flash memory, optical disks, magnetic disks, etc. In one embodiment, when sensor node 125 executes computer-executable instructions installed in data storage device 360, processor 313 may load at least a portion of instructions from data storage device 360 into memory 316.

Clock 320 may be one or more devices adapted to measure the passage of time in base node 120 or sensor node 125. Consistent with embodiments disclosed herein, using clock 320, a sensor node 125 may, in some cases, determine when to change states between periods of dormancy and non-dormancy. Since clock 320 may not be synchronized with other nodes in the network, different sensor nodes 125 may be in different states at the same moment in time.

Transceiver 350 and antenna 355 may be adapted to broadcast and receive transmissions with one or more of network nodes 120-130. Transceiver 350 may be a radio-frequency transceiver. Consistent with embodiments of the present disclosure, transceiver 350 may be a Chipcon CC3510 microcontroller/RF transceiver and antenna 355 may be an inverted F-type antenna. Transceiver 350 may transmit and receive data using a variety of techniques, including Direct Sequence Spread Spectrum (DSSS) or Frequency Hopping Spread Spectrum (FHSS). In addition, antenna 355 which may be an inverted F-type antenna, is integral to the circuit board and is situated at the top of the unit for a maximal transmission aperture. Antenna 355 may be adapted to provide a radiation pattern that extends substantially above ground but generally not below, in order to minimize the amount of radiated power transmitted into the ground.

Data storage device 360 may be associated with sensor node 120 for storing software and data consistent with the disclosed embodiments. Data storage device 360 may be implemented with a variety of components or subsystems including, for example, a magnetic disk drive, an optical disk drive, a non-volatile memory such as a flash memory, or other devices capable of storing information.

Power supply 370 may be any device for providing power to sensor node 125. Consistent with embodiments disclosed herein, sensor nodes 125 may be standalone devices and power supply 370 may be a consumable source of power. For instance, power supply may be a battery, fuel cell, or other type of energy storage system. Accordingly, by reducing power consumption (using dormant periods, for example), sensor nodes 125 consistent with the present disclosure may reduce costs for maintaining sensor network 115 by minimizing the need to replace power supply 370. Power supply may include additional components for generating and/or scavenging power (e.g., solar, thermal, kinetic, thermal, or acoustic energy) to extend the life of power supply 370 before requiring replacement.

In an example consistent with embodiments of the present disclosure, sensor nodes 125 may be installed at or below ground level, such that the majority of the node will be below ground and only antenna 355 will protrude. This proximity to the ground may introduce a high degree of multipath fading, due to reflections from the ground, and an element of frequency-selective fading due to absorption of certain wavelengths by surrounding materials such as uncut grass. Advantageously, the in-ground sensor nodes 125 can be equipped with antenna (such as F-type antennas) which direct most of the broadcasted signal above the plane of the ground surface. This can be combined with frequency diversity (such as FHSS), space diversity (multiple nodes=multiple receiving antennas) and message redundancy (same data packet rebroadcast multiple times on each of multiple frequencies) to increase the likelihood that data packets containing status information about a particular node 125 will be received by other node, including base node 120.

Continuing the aforementioned example, sensor node 125 may be a pest sensor employed by a perimeter of sensor nodes around structure 105, wherein the sensors 340 use optical transmission through a sheet of termite bait to detect activity. Sensor 340 may test the opacity of a bait material to detect areas which have been eaten away by termites. In some embodiments, a sheet of bait material is sandwiched between two lightguides, one on each side of the circuit board. One lightguide angles a light-source normal to the bait material and the other directs any light passed through the bait material back to a detector on the other side of the circuit board. In the absence of termites, the bait material absorbs the majority of the incident light and the detector gives a low output. However, if some fraction of the bait material is eaten, additional incident light passes through to the detector and a sensor hit is flagged. Although the exemplary pest sensor is described as using light to detect pest, alternative methods known in the art of pest detection may be employed. For example, pest sensors consistent with embodiments disclosed herein may detect parameters based on changes or alterations in magnetic, paramagnetic and/or electromagnetic properties (e.g., conductance, inductance, capacitance, magnetic field, etc.) as well as weight, heat, motion, acoustic or chemical based sensors (e.g., odor or waste).

FIG. 3B illustrates a functional block diagram of exemplary sensor node 125. Controller 310 may execute software processes adapted to process, store, and transmit information received from sensor 340 and transceiver 350. In addition to an operating system and/or software applications known in the art, controller 310 may execute a data encoder/decoder module 365, data acquisition module 375, and status memory 370.

Encoder/decoder module 365 a software module containing instructions executable by processor 313 to encode and/or decode status packets received by transceiver 350 via antenna 355. Encoder/decoder module 365 may decode status data packets broadcast by other nodes of sensor network 115 and received by transceiver 350 via antenna 355. As illustrated in FIG. 3B, when status data and/or service data is received, this data may be stored in status memory 370 along with data previously received from other nodes in sensor network 115 during a particular communication cycle.

Status memory 370 may be a memory for storing, querying, and retrieving status data about sensor network 115. Status memory 370 may include an entry corresponding to each node included in sensor network 115. In accordance with some embodiments, status memory 370 may be implemented as a mySQL database; an Open Source database engine implementing the Structured Query Language. Status memory 370 may include an entry corresponding to each node included in sensor network 115. Consistent with some embodiments, sensor network 115 may be configured to include a predetermined number of network nodes (e.g., 40 nodes) and status memory 370 may include entries corresponding to the predetermined number, which may be more than the actual number of nodes in sensor network 115.

Data acquisition module 375 may continuously poll the communication interface 314 to which the sensor 340 and transceiver 350 are connected. Data received from sensor 340 may be processed and stored in status memory 370 by data acquisition module 375.

Relay node 130, which may be a device similar to the sensor node 125, may be included in sensor network 115 in circumstances where sensor nodes 125 are not within broadcast range, or in which a clear communication path cannot be guaranteed between two nodes in network 115. For example, relay node 130 may be used to pass sensor data between sensor nodes 125 that would otherwise be unable to communicate due to obstructions or terrain. In some embodiments, the relay node 130 may be packaged in a housing similar to that of a sensor node 125. In other embodiments, such as when an obstruction is on the ground, rely node 130 may be packaged to be installed at an increased elevation relative to a ground surface in which sensor nodes 125 are located, such as in the eaves of structure 105 around which network 115 is installed.

Service node 135 also may be a device including components similar to sensor node 125, as illustrated in FIG. 3A. As noted above, service node 135 may be a device for deploying and servicing sensor network 115. Consistent with some embodiments, service node 135 may be adapted for being man-portable and include a user interface allowing technician 137 to interact with the device. Technician 137, for example, may employ service node 135 to ensure that network nodes 120-130 are installed within broadcast range of one another. Additionally, service node 135 may be used to locate and/or service network nodes 120-130 when, for instance, an event disables a network node 120-130. In order to simulate sensor nodes 125, the service node 135 may include the same type of antenna as provided in sensor nodes 125. However, service node 135 may also provide indication of the quality of a signal received from one or more nodes to technician 137 while seeking a suitable spot for deployment of the next one of sensor node 125. In this case service node 135 may be in technician 137's hand and receiving signals from below, where the radiation pattern is weakest. The service node 135 may consequently experience difficulty receiving signals in this case.

The service node 135 may operate in either upward or downward orientation to enable the antenna to radiate either side of its horizontal plane according to a task. The service node 135 also may provide a display (e.g., an LCD screen) on both the top and bottom faces of the device, as well as user-input buttons may be provided on the sides of the housing. In one embodiment, an antenna may protrude from the far end of the unit and may be covered by a plastic cap matching that of sensor nodes 125, such that the antenna is at the same level as those of the sensor nodes 125 when the service node 135 is placed at ground-level.

The user-interface provided by service node 135 may include one or more indicators. In some embodiments, the user-interface, as noted above, may indicate the quality of a signal received from one or more network nodes. The quality of the signal may be based on value indicative of, for example, the strength of the signal and/or the data error rate of the signal (e.g., bit-error-rate). In other embodiments, the user interface may provide a display indicating the network identifications of the network nodes 120-130 within range of service node and, in some cases, together with a signal quality indicator for each of the nodes. For example, service node 135 may display a list of each node and, in some embodiments, a indicator of signal quality for each node listed.

The configuration or relationship of the hardware components and software modules illustrated in FIGS. 2A-3B are exemplary. The components of sensor node 125 may be independent components operatively connected, or they may be integrated into one or more components including the functions of some or all of components 210-280 and 310-375. Different configurations of components may be selected based on the requirements of a particular implementation of base node 120 or sensor node 125, giving consideration to factors including, but not limited to, cost, size, speed, form factor, capacity, portability, power consumption, and reliability, as is well known. Moreover, a base node 120 or sensor node 125 useful in implementing the disclosed embodiments, may have greater or fewer components than illustrated in FIG. 2A or 3A.

FIG. 4 is a state diagram illustrating exemplary states of sensor node 125. Consistent with some disclosed embodiments, states may include a dormant-state, a listen-state, a communicate-state, a realignment-state, and a service-state. The dormant-state may be a very low power state having a predetermined period during which a node remains substantially inactive. Consistent with the disclosed embodiments, sensor node 125 spends a majority of its time in the dormant-state to conserve power. In the dormant-state, sensor 340 and transceiver 350 and data storage device 360 of sensor node 125 may be deactivated and the controller 310 may operate at a very low power. The predetermined period of the dormant-state may be determined from clock 320. In some instances, to maximize power conservation, clock 320 may include a low-power clock used during the dormancy period. During a non-dormant state, another, higher-power clock required for processing by controller 310 may be activated instead. At the end of the predetermined dormant-state period, sensor node 125 may enter a non-dormant-state during which data may be received and/or communicated.

Sensor node 125 may enter the listen-state after the predetermined dormant-state times-out. The listen-state is a non-dormant state during which sensor node 125 operates at low power waiting for communication from another node (a.k.a. “wake-on-radio”). Transceiver 350 may, for instance, be activated to receive data packets broadcast from other nodes but, during listen-state, sensor node may not broadcast any data packets. Sensor node 125 may remain in the listen-state for a predetermined period of time or until a communication is received from another node in the same sensor network 115.

If a communication is received during the listen-state, or if the listen-state period ends, sensor node 125 may change to the communicate-state. Consistent with some embodiments, sensor node 125 will only undergo a transition when a valid data packet is received from a node belonging to sensor network 115. In particular, each data packet may include a sensor network identifier and a node identifier. After receiving a communication, sensor node 125 may verify, based in part on the network ID and node ID, that the received data packet is from another node in the same sensor network 115. By verifying the sensor network 115 is the source of a communication received by sensor node 125, false triggers may be avoided, for instance, due to communications broadcast by another nearby sensor network or other sources broadcasting data on interfering frequencies. Otherwise, if no communication is received, sensor node 125 may remain in the listen-state until the end of the predetermined period, as determined by clock 320.

During the communicate-state, sensor node 125 may broadcast data packets and receive data packets broadcast by other nodes. In the communicate-state, base node 120 may also broadcast a data packet including data fields that trigger sensor nodes 125 to enter a service-state prior to a service visit. The communicate-state may continue for a predetermined period, or until a communication is received from a node that is entering the dormancy-state. In the first case, at the end of a predetermined communication period determined based on clock 320, if a communication had been received from another node and the predetermined communication-state period is timed-out, sensor node 125 may store status information indicating that sensor node 125 is dormant, broadcast the stored information in a data packet, and re-enter the dormant-state for a predetermined period of time. In another case, when sensor node 125 has received a communication from another node of sensor network 115 and the communication indicates the other node is in the dormancy-state, sensor node 125 may, after storing the status information received from the other node and store status information of itself, including information indicating that the node 125 is dormant, broadcast the stored information in a status packet, and re-enter the dormancy-state without waiting for the end of the predetermined communication period.

In the realignment-state, sensor node 125 may attempt to reestablish communications with sensor network 115 after failing to receive a valid communication from another node in network 115 during the communication-state. When a node does not receive information from another node, the states of sensor node 125 may have fallen out of alignment with other nodes in sensor network 115 due to, for example, drifting of clock 320 over time. To reestablish communication with sensor network 115, sensor node 125 may realign its operational cycle with other nodes in network 115 by modifying the duration of the dormancy-state.

Sensor node 125 may be placed in service-state in preparation for service by technician 137. The service-state may be initiated in more than one circumstance. In one case, the service-state may be initiated when sensor 125 receives a service command in a data packet broadcast from another node. Consistent with some disclosed embodiments, a pest control provider, via remote station 150, may request that sensor network be placed in service-state within a predetermined time in advance of a service visit by technician 137. In another case, sensor node 125 may initiate the service-state if communications with another node cannot be established after the end of the realignment-state. While in the service-state, sensor node 125 may, in some instances, enter a low-power mode during which sensor node 125 waits and listens for communication from another node—particularly, service node 135, carried by technician 137.

By providing sensor nodes 125 in an ad hoc network having extended dormant-states, sensor nodes 125 in sensor network 115 may operate for extended periods without service, such as having power sources replaced and thereby reducing costly service visits by technicians. In addition, by communicating on an ad hoc basis, sensor network 115 is highly robust since sensor nodes may be added or removed from the system without impacting the overall operation of network 115. Further, by using an ad hoc scheme, sensor nodes may conserve power since no synchronization is required. Although the aforementioned states discussed with regard to sensor node 125, in some embodiments, relay node 130 may have the same states and may also be a sensor node. Sensor nodes 125 and base node 120 may also serve as relay nodes to connect otherwise separate portions of a particular network installation.

FIG. 5 illustrates an exemplary data packet 500 broadcast from a node in sensor network 115. Communication between base node 120, sensor nodes 125, and/or relay node 130 may be implemented using a data packet protocol consistent with embodiments disclosed herein. Data packet 500 may include synchronization data 505, data fields 510-560 and check data 565.

Synchronization data 505 may include information for synchronizing an incoming data packet 500 including. For instance, synchronization data 505 may include a number of preamble bits and a synchronization word for signaling the beginning of a data packet 500. Furthermore, in some embodiments, synchronization data 505 may provide information identifying the length of the data packet. Data fields 510-560 that contain status information stored in a network node about the network node, as well status information received by the node from broadcasts of other nodes. Information may be any form: bit, text, data word, etc. Check data 565 may include information for verifying that a received data packet does not include errors; for example, a cyclic redundancy check or the like.

Data packet 500 may includes a number of data fields including status information of a plurality of nodes 120-130. As shown in FIG. 5, for instance, exemplary data packet 500 includes status information of node A 125A, node B 125B and node C 125C. Of course, a particular data packet 500 may include more or less information depending on what status information has been received by a particular one of nodes 120-130 and stored in that particular node's status memory 370.

Exemplary data fields within a data packet 500 may include a network identification 510, node identification 520, node status 530, communication status 540, power status 550, and sensor status 560. Network identification (“ID”) 510, may identify sensor network 115 to distinguish the network from, for instance, an adjacent sensor network. As such, two or more networks can by located adjacently, or even intermixed, without data from one being captured by the other. Node ID 520 may uniquely identify one of nodes 120-130 such as sensor nodes 125 or relay nodes 130 in sensor network 115.

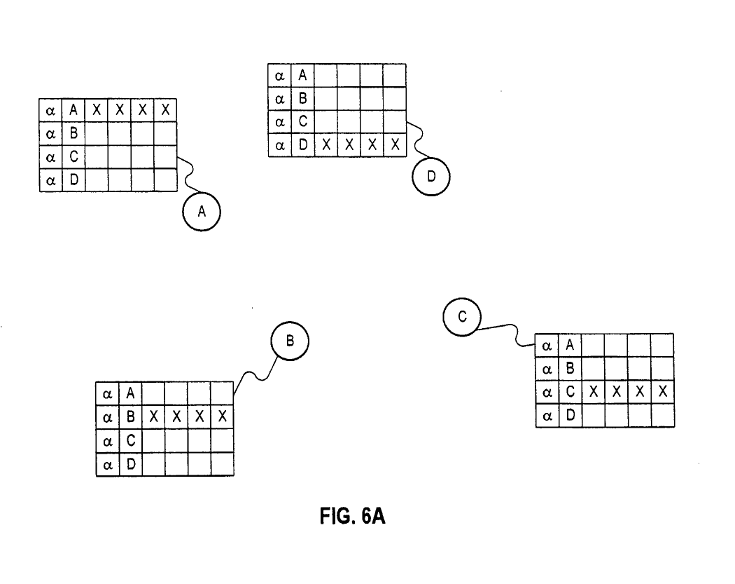

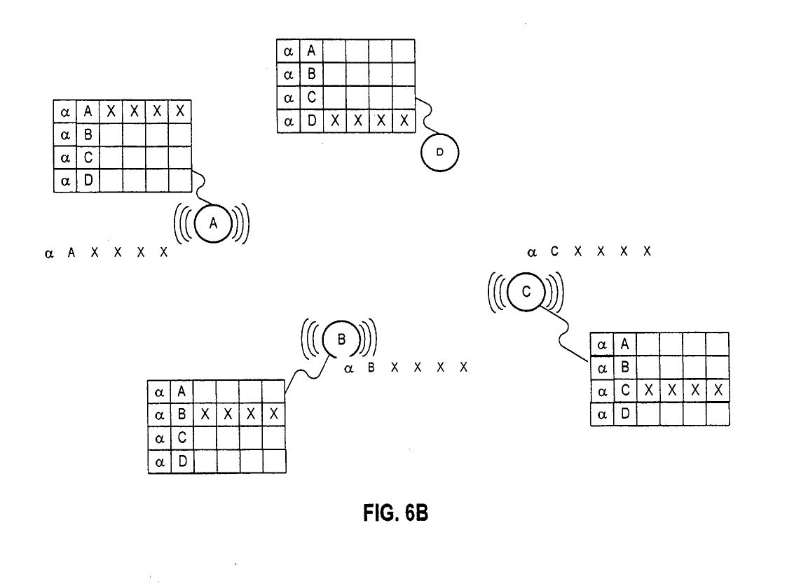

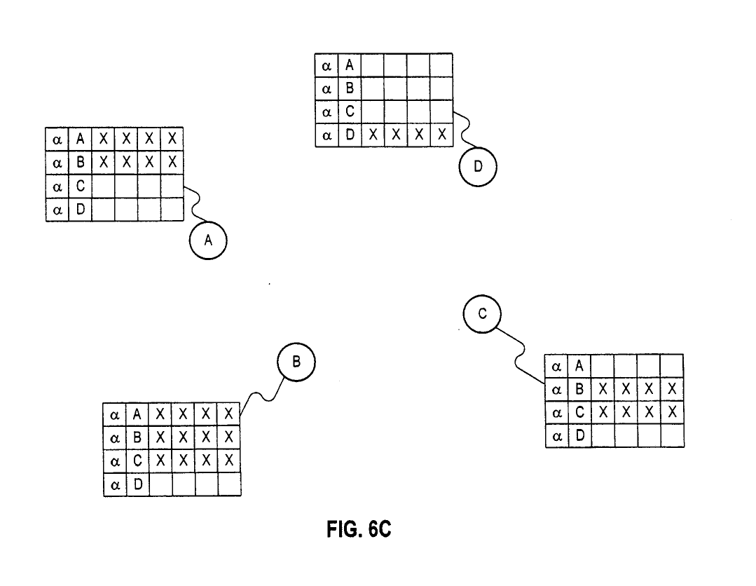

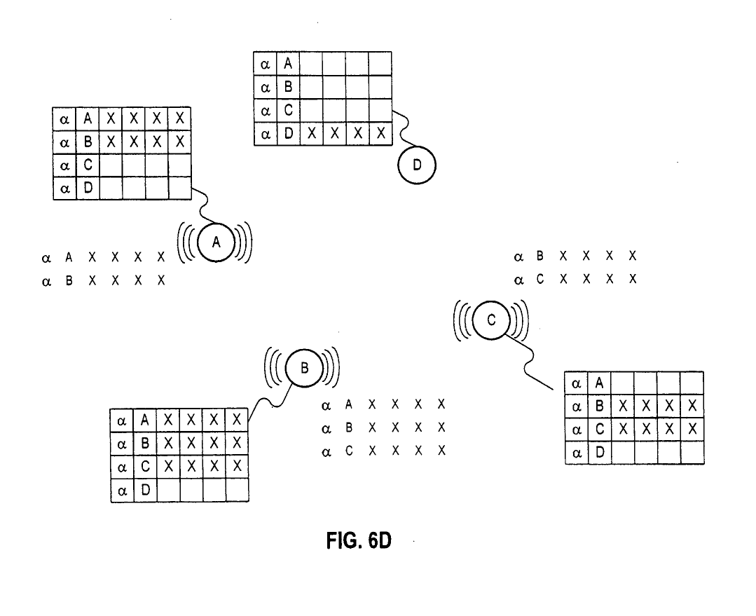

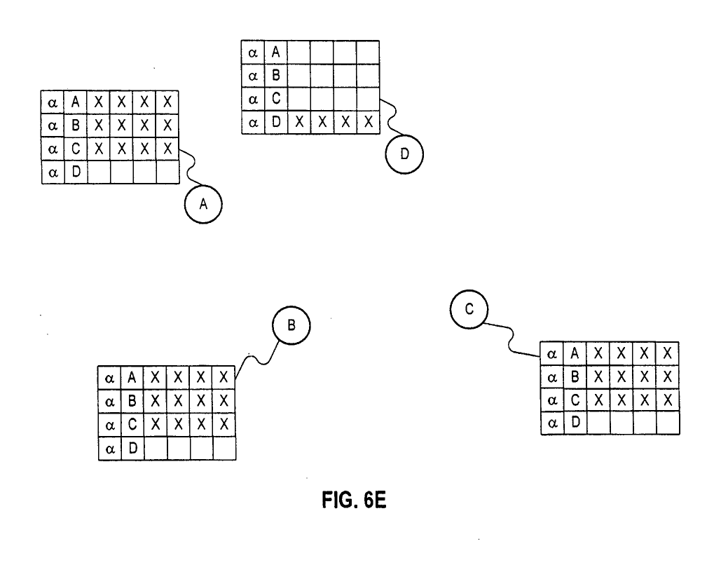

In some embodiments, data packet 500 may be broadcast from a node without being specifically identified with the node of its origin and the receiving node may not require specific packet origin information (other than a network ID to distinguish the packet from adjacent networks). In such embodiments, the broadcast data packet 500 may contain a network ID 510 but not a node ID 520 since the packet is not being specifically addressed to another node. Status information for each node in network 115 may be stored in a unique field in the data packet corresponding to such node. For example, as shown in FIGS. 6A-6E, sensor information for Node A may be located in a first position in data packet 500 corresponding to Node A, status information for Node B may be stored in a second position in data packet 500 corresponding to Node B, and so on. Accordingly, when a broadcast data packet 500 containing such status information is received by another node, the receiving node may add the information to its knowledge of the network by storing the information in its status memory 370 in a data field which corresponds to the particular node. If the receiving node is still in the communication-state, it may subsequently broadcast a data packet 500 which now also contains information about the particular node.

Node status 530 may indicate that sensor node 125 is preparing to enter a dormant-state. In some embodiments, node status 530 may indicate that the node is entering a service-state in response to a command message sent from remote station 150. Communication status 540 may indicate that the node has communicated its data to another node. Power status 550 may indicate the status of a node's power supply. For example, it may indicate that the node's batteries are low. Sensor status 560 provides a value indicating whether sensor 340 has detected a condition.

Consistent with some embodiments of the present disclosure, status may be an array of Boolean values, wherein a “true” value in the node status 530 indicates that the unit is preparing to go to a dormancy-state. A “true” value in communication status 540 may indicate that the node has broadcast its status. A “true” value in the power status 550 may indicate a low battery. And, a “true” value in the sensor status 560 may indicate that sensor 340 has been triggered by an event such as termite activity. The node status 530 and communication status 540 may vary according to the stations positioned in its cycle, while the sensor and battery flags should remain “false.” A “true” value in either of these flags indicates a problem, which requires the attention of technician 137.

FIGS. 6A-6F are block diagrams illustrating an exemplary process for propagating data packets between nodes of exemplary sensor network 115, identified as α. As shown in FIG. 6A, exemplary sensor network 115 may include four sensor nodes A, B, C, and D, that have not communicated each node's respective status information. Each of nodes A, B, C, and D may be initially in a dormant-state.

FIG. 6B illustrates each of exemplary nodes A, B, and C broadcasting its respective data packet including data fields 510-560 which contain status information. As shown in FIG. 6B, because each node has a limited communication range, each node may only receive a data packet from neighboring nodes in that range. Also, since each node has not communicated with another node yet, each node only communicates status information about itself. Furthermore, in accordance with the present example, exemplary node D remains in a dormant-state and, therefore, does not broadcast or receive data packets from the other nodes. As such, nodes A, B, and C also do not receive status information about node D.

FIG. 6C illustrates each of non-dormant nodes A, B and C having received a data packet from it's neighboring nodes. In particular, nodes A and C neighbor node B and, therefore, only receive a data packet from node B. Node B, in comparison, neighbors both node A and node C. As such, node B has received a data packet from each of node A and node C. After receiving a data packet, each node may store the included status information in its respective status memory 370. For instance, FIG. 6C illustrates node B having stored status information of node B, as well as nodes A and C. Also, because node D has remained dormant, no data with regard to this node is stored by nodes A, B, or C.

FIG. 6D illustrates another subcycle of broadcasts by nodes A, B, and C in communication-state within a particular cycle. Here, each node has again broadcast a status packet including each node's status information stored its respective status memory 370. In this cycle, the status information includes status information received from another node. For example, node A may receive status information about node C included in the status packet broadcast from node B (and vice versa).

FIG. 6E illustrates nodes A-C after again receiving a packet. As shown, because the received packet includes information from a non-adjacent node, a plurality of nodes may propagate status information around the entire sensor network 115, even though certain nodes (e.g., node A) may be out of range of at least one other node (e.g., node C). In this manner, base node 120 may receive status information from each of the nodes in sensor network 115 and communicate status messages to remote station 150 including the status of every node in the network.

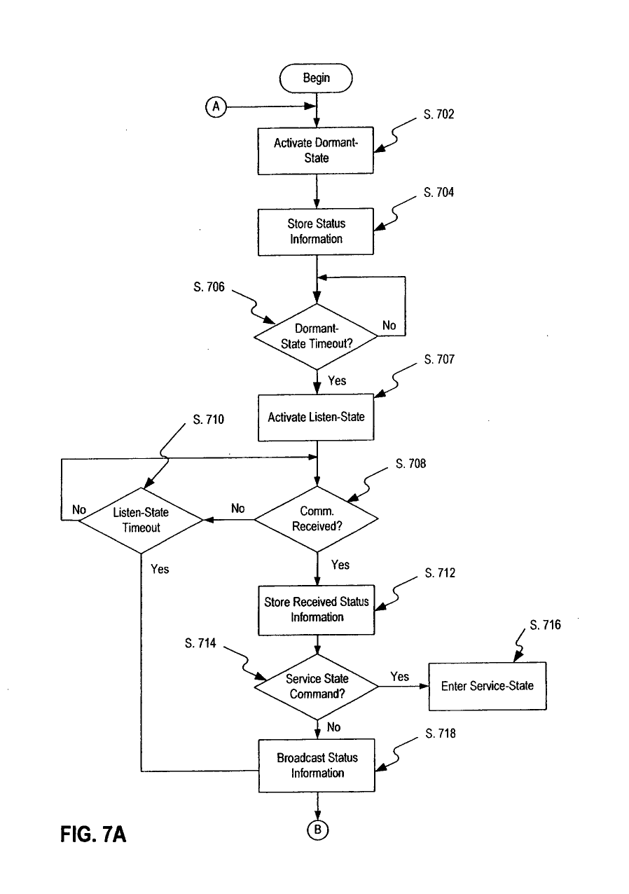

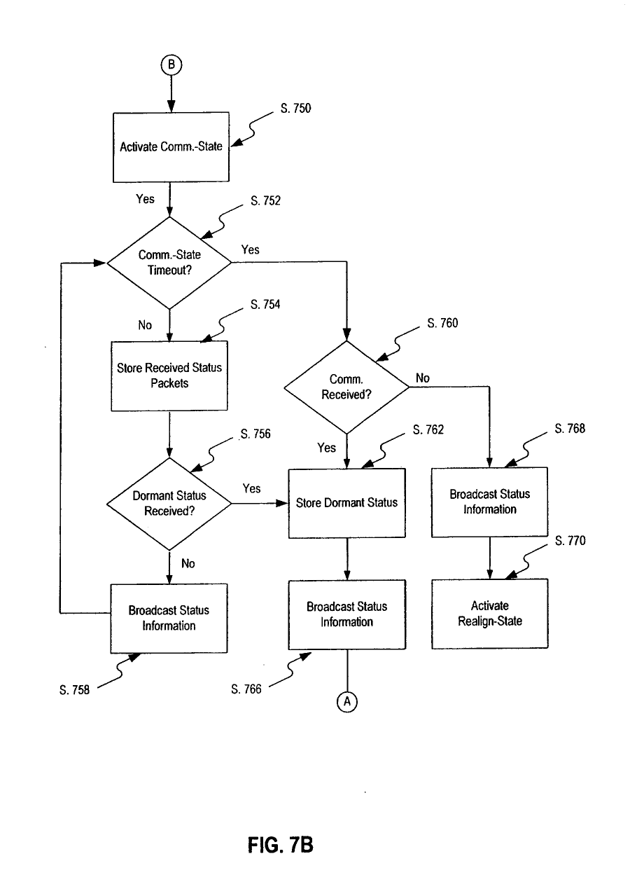

FIGS. 7A and 7B provide a flow diagram of an exemplary process, consistent with some of the disclosed embodiments. In accordance with this exemplary embodiment, sensor node 125 may be configured to cycle through a plurality of states as described above with regard to FIG. 4. Assuming the cycle starts in the dormant-state, sensor node 125 may begin by initiating the dormant-state (step 702) and storing status information (step 704). For instance, controller 310 in sensor node 125 may interrogate sensor 340 and/or power source 370 and store information in status database indicating the current status of these components. As noted above, status information of sensor 340 may be Boolean values indicating whether or not the sensor has been triggered, and whether power source 370 power is low.

In the dormant-state, sensor node 125 determines whether the predetermined dormant period has ended. (Step 706.) If not, sensor node 125 remains in dormant-state to conserve power. (Step 706, no.) If, however, the predetermined dormant period has ended (step 706, yes), sensor node 125 may store status information relating to its battery and sensor 340 (see step 704) and then initiate the listen-state (step 707) during which the node 125 may activate transceiver 350 and wait for a predetermined period of time to receive a communication from another node in sensor network 115.

During the listen-state, sensor node 125 may determine whether a communication has been received. (Step 708.) If not (step 708, no) and the predetermined period for the listen-state is not timed-out (step 710, no), then sensor node 125 will continue to wait for a communication in listen-state If, on the other hand, the predetermined period for the listen-state has ended (step 710, yes), sensor node 125 may broadcast the stored status information (step 718) and initiate the communication-state (step 750).

In the other circumstance, in which a communication is received while sensor node 125 is in the listen-state (step 708, yes), sensor node 125 may store the received status information along with the status information of sensor node 125 in status memory 370. In some embodiments, sensor node 125 verifies that the communication is valid before storing the received information. For instance, sensor node 125 may verify that the received information was received from another node in sensor network 115 based on a network ID.

In addition, sensor node 125 may determine whether the received status information included a service-state command. (Step 714.) If so, (step 714, yes) then sensor node 125 may transition to the service-state (step 716). If not (step 714, no), then sensor node 125 may proceed to broadcast its status information stored in status memory 370 (step 718) and initiate the communicate-state (step 750).

After initiating the communicate-state (step 750), sensor node 125 may determine whether the predetermined communicate-state period has timed-out (step 752). If not, (step 752, no), the node 125 may listen, via transceiver 350, for valid data packets and store any received status information contained therein in status memory 370 in association with the node ID 520 of the respective node (step 754.)

Further, sensor node 125 will determine whether or not a status packet indicating another node has entered the sleep state. (Step 756.) If no, information indicating another node has entered a dormancy-state (step 756, no), then sensor node 125 may broadcast a status packet including the information stored in status memory 370 (step 758) and then continue at the beginning of the communication-state cycle by, again, checking whether the communicate-state period has timed-out (step 752).

If, however, sensor node 125 has received a status packet indicating that another node had entered the dormancy-state (step 756, yes), the sensor node 125 also may store information indicating that it is entering the dormant-state in sensor node 125's respective entry in status memory 370 (step 762). Then, sensor node 125 may broadcast the stored information stored in status memory 370 (step 766) and re-initiate the dormant-state (step 704).

Under the circumstance that the communication-state has timed-out (step 752, yes), sensor node 125 may determine whether any valid communication have been received from other nodes in sensor network 115 (step 760). If, at the end of the communicate-state period, a communication has been received (step 760, yes), the sensor node 125 stores information indicating that it is entering the dormant-state in sensor node 125's respective entry in status memory 370 (step 762). Then, sensor node 125 may broadcast the stored information stored in status memory 370 (step 766) and re-initiate the dormant-state (step 704). However, if no communication has been received by sensor node 125 by the end of the communication-state period (step 760, no), the node may proceed to broadcast the status information stored in status memory 370 (step 768) and initiate a realignment-state (step 770). In some cases, stored status information also may be broadcast more than once to increase the opportunity of communicating with another node before initiating the realignment-state.

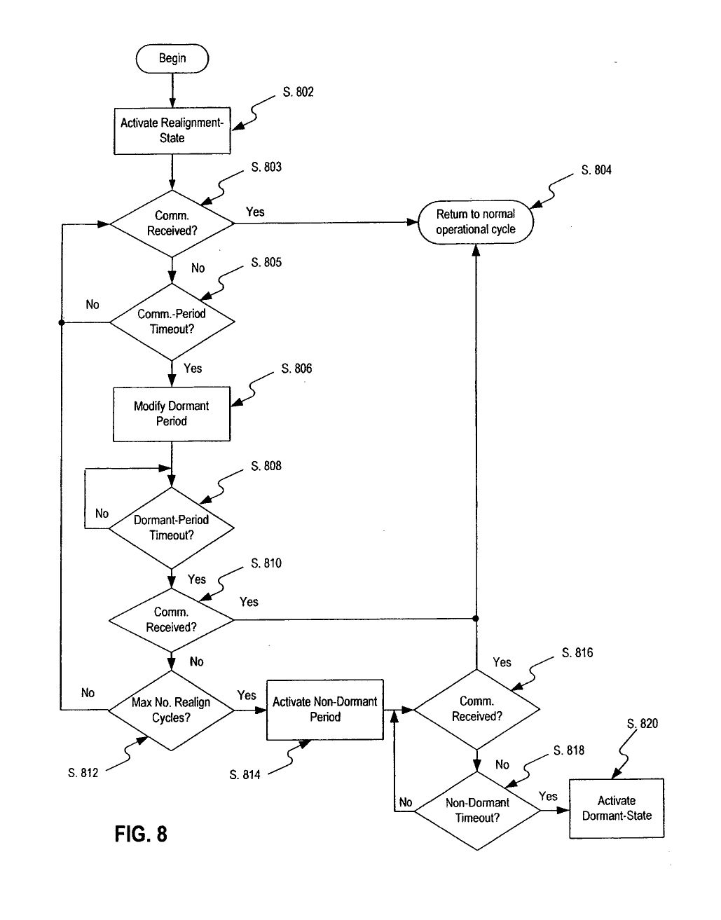

FIG. 8 provides a flow diagram of an exemplary process for realigning a sensor node 125, consistent with some of the disclosed embodiments. It is expected that, due to changes at location 110 over time, a sensor node 125 may lose communication with sensor network 115. For instance, where the exemplary sensor node 125 is an in-ground pest detection station in the yard of a residence, changes to the yard (e.g., placement of garden furniture and similar items) may obstruct broadcasts from a sensor node and, as a result, the sensor node 125 will no longer be able to communicate with neighboring network nodes. Sensor node 125 may remain out of communication such that, when the obstruction is eventually removed, the states of sensor node 125 may be out of alignment with other nodes in sensor network 115 due to drifting of the node's clock 320 relative to its neighbors. Therefore, if during the listen-state and/or communication-state, the sensor node 125 does not receive a communication from its neighbors, sensor node 125 may enter a realignment-state.

After realignment-state is initiated by sensor node 125 (step 802), the node, using transceiver 350, may listen for communications from other nodes in sensor network 115 for a predetermined period of time (step 803). If a communication is received (step 803, yes), realignment-state ends and the node may return to its normal operating cycle (step 804), such as a communication state (FIG. 7B). If, however, no communication is received (step 803, no) and the predetermined period timed-out (step 805, no), then sensor node 125 may modify the dormant-state period (step 806.) The length of predetermined dormant period may be modified by placing the node in a non-dormant-state for a certain period at the beginning, end, and/or other period during the typical dormancy period. During this modified non-dormant period, sensor node 125 may maintain a low-power state during which it listens for communications from other nodes in sensor network 115. As a consequence, sensor node 125 may receive a status packet from another network node having state cycles out of alignment with sensor node 125.

If, after modifying the dormant period, a communication is received from another node in network 115 (step 810, yes), realignment-state ends and the node may return to its normal operating cycle (step 804), such as a communication state FIG. 7B). If not (step 810, no), sensor node 125 may determine whether the realignment mode has completed a maximum number of cycles (step 812). If not (step 812, no), then sensor node 125 may begin a new realignment-state cycle (step 802).

If the maximum number of realignment cycles is exceeded (step 812, yes), rather than reentering a dormant-state, node 125 may enter a non-dormant-state for a predetermined period of time (step 814). For instance, sensor node 125 enters a listen-state for an extended period of time in a last attempt to reestablish contact with sensor network 115. If communication is received during this non-dormant-state (step 816, yes), realignment-state may end and the node may return to another normal operating state (step 804), such as a communication state (FIG. 7B). If no communication is received (step 816, no), node 125 may enter a standby mode and not attempt further communication with the network. For example, if no communication is received during a standby period of twenty-four hours, the node may be blocked from communication or, the antenna may have been damaged. In such case, node 125 may perform one of several remedial measures including: shutdown, enter service-state, enter listen-state, or activate a beacon signal. Thus, for example, technician 137 may use the service node 135 to locate the misaligned sensor-node 125.

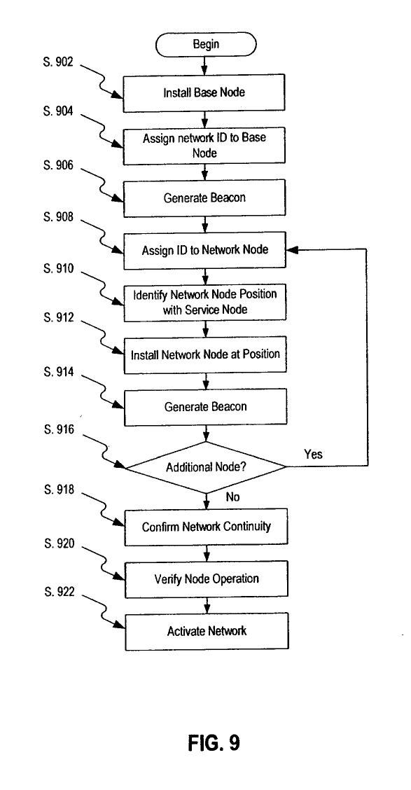

FIG. 9 provides a flow diagram of an exemplary process for installing sensor network 115, consistent with some of the disclosed embodiments. Generally, during installation of sensor network 115, each network node is sequentially deployed and the node's ability to communicate with at least one preceeding node is verified. Technician 137 may first install a base node 120 in a suitable location within the property (step 902) and assign a network ID (step 904). Base unit 120 may be located near an access point to communications channel 140; for example, a telephone socket on the wall or an ethernet router within a building or structure. Once installed, base node 120 may generate a beacon signal that will be used as reference when selecting locations of subsequent network nodes. (Step. 906). In order to ensure that each node is within range of at least one preceeding node, the beacon is propagated around as much of network 115 as is in place. As each subsequent network node is placed, it retransmits this beacon with an incremented status packet. The beacon then propagates through the installed nodes. In addition, service node 135 may use the beacon both to confirm that continuity exists within the network and to measure the signal quality (strength, bit error rate, etc.) at a given location.

Next, a subsequent sensor node 125 or relay node 130 to be installed is assigned a node ID. (Step 908.) Technician 137 may then identify a position to place the next node based on the quality of signal received from the at least one preceeding node as a guide to transmission range (step 910) and the node may be installed at the selected position (step 912). The installed node (in addition to any previously installed nodes) may generate a beacon to guide the placement of the next node. (Step 914.) If another node is to be placed (step 916, yes), the same process may be followed. After all nodes are placed (step, 916, no), technician 137 may confirm continuity of communication between all the nodes of new sensor network 115 (step 918) and verify that all nodes of network 115 are operating properly (step 920). As such, base node 130 may instruct sensor network 115 to enter the first state in the normal operating cycle. The sensor nodes 125 and/or relay nodes 130 may interrogate sensor and battery status and broadcast status packets accordingly. Upon completion of the cycle, technician 137 may verify each node's status at the base node 130 and, if correct, activate sensor network (step. 922.)

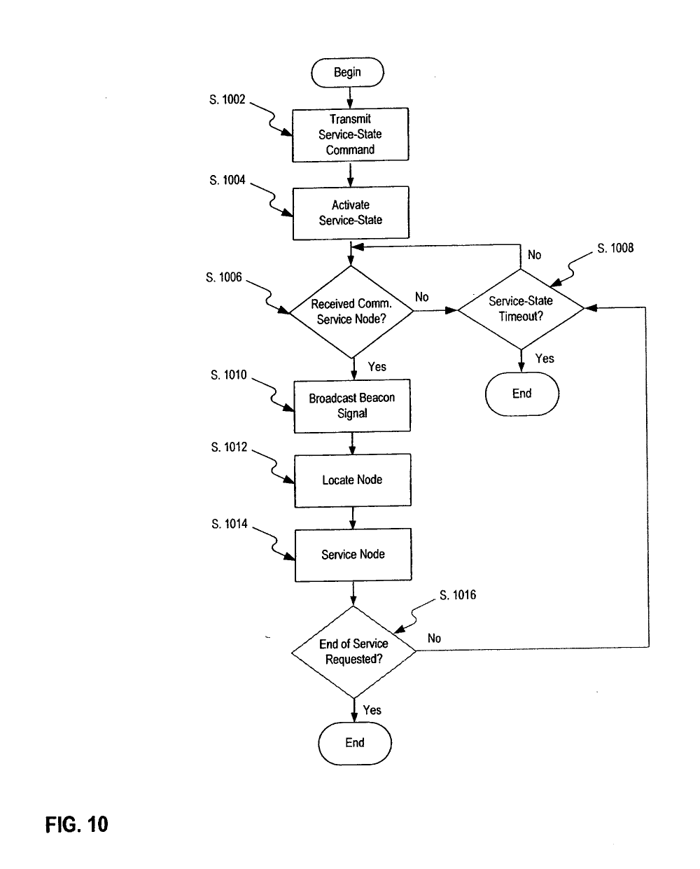

FIG. 10 provides a flow diagram of an exemplary process for servicing sensor network 115, consistent with some of the disclosed embodiments. A service visit might require nodes to be replaced or added to the network. For instance, consistent with, an exemplary embodiment, network 115 may require service when a node needs replacing, either because of a termite hit or a low battery, or when one or more of the nodes are not communicating. In such cases, technician 137 may visit a location to service a sensor station 125.

A service visit requires that the nodes are responsive to the service node 135. Accordingly, technician 137 may communicate with sensor network 115 in advance of a service visit so that network nodes may be in service-state. For instance, using remote station 150, technician 137 may issue a command to sensor network 115 to enter service-state. (Step 1002.) As a consequence, the service-state command may be received at base node 120 from remote station 150 over communication network 140 and the service-state command may be propagated to the network nodes in status packets as part of the node's aforementioned communication-state. In some embodiments, the service-state command is indicated by setting the sensor status flag 560 for base node 120 to “true.” After receiving the service-state command, sensor node 125 may, for a predetermined period of time (e.g., thirty-six hours), enter a service-state (step 1004), which may be a special low duty-cycle listen-state, such that network nodes are able to communicate with the service node 135.

Sensor nodes 125 in the service-state are configured to broadcast a beacon signal upon receipt of a communication broadcast from service node 135. Accordingly, if no communication is received from service node 135 (step 1006, no) and a predetermined service-state period had not timed-out (step 1008, no), the network nodes will remain in the service-state. If, however, the service-state has timed-out (step 1008, yes), network nodes may terminate the service-state and return to the normal operating cycle.

When a network node receives a communication from service node 135 while in the service state (step 1006, yes), the network node may broadcast a beacon signal (step 1010) that technician 137, using service node 135, may use to home-in on the location of the node in question (step 1012). For instance, using directional indicators displayed by service node 135 in response to data packets 500 being repeatedly sent by one or more of network nodes 120-130 in range of service node 135, technician may determine the location of an in-ground node that is otherwise out of sight. The indicators may be based on a quality of signal received by the service node 135 from the in-ground node. The quality of signal may be determined from a value indicative of the strength of the beacon signal and/or a value indicative of data error rate of the beacon signal (e.g., bit-error rate). In other instances, technician 137 may use service node 135 to “browse” nodes in sensor network 125. When browsing, each network node 120-130 in range of service node 135 may transmit the node's respective identifier (node ID). Using the received identifier, service node 135 may, for example, display a list of nodes in range. After locating a desired one of nodes 120-130, technician 137 may service the node by repairing or replacing the node in the normal fashion. (Step 1014.)

In some embodiments, technician 137 may also add and replace nodes in network 115 without commanding network 115 to enter service-state. In this case service node 135 may program the new node with a network ID and node ID. Because sensor network 115 may be configured to include a predetermined number of network nodes, a new node may be seamlessly added to sensor network 115 in a preexisting slot within the network, occupying a predetermined entry in status database 270 and/or status memory 370. The added node, after being added to the sensor network 115, may enter the realignment-state and communicate with sensor network 115 on an ad hoc basis during the node's next communication-state. As such, when a node is being replaced with a new node, the replacement node may simply be inserted into the existing location.

After serving a node technician may optionally request end of service-state using service node 135. (Step 1016.) If not, and the predetermined service-state period had not timed-out (step 1008), then technician may continue to service sensor network 115. However, if technician requests end of service-state, service node 135 may broadcast a command to end the service-state. Network nodes 120-130 within range of service node 135 may receive the command and propagate the command to other ones of network nodes 120-130, as described previously. After receiving a commend to end the service state, nodes 120-130 of sensor network 115 may return to the normal operating cycle, such as by entering the dormant-state or the communicate-state.

### ILLUSTRATIVE EXAMPLE

Consistent with some of the embodiments disclosed herein, testing was undertaken to demonstrate the feasibility of deploying a network of wireless sensors for the detection of insect species in a residential property environment. The study covered most aspects of telemetry, including sensor deployment, in addition to battery life and environmental suitability. It did not, however, address the performance of the insect sensor itself, the details of which are specific to the insect species being considered.

The communication link for the test sensors including the base unit was provided by the Chipcon CC2510 which incorporates a microcontroller and RF transceiver. An inverted F-type antenna was integral to the circuit board containing the sensor and is situated at the top of the unit for a maximal transmission aperture in the 2.4 GHz ISM band. Power for each sensor was provided by two standard AA alkaline cells.

In the sensors employed in the test, the CC2510 was mounted on a printed circuit board within a moulded plastic capsule, which can be inserted into the ground in the same fashion as conventional termite bait stations. The circuit board contains the sensor, the antenna and the battery mountings. The inverted F type and is integrated into the upper end of the circuit board such that it protrudes above ground level when the capsule is in position (unless it is deployed as an above-ground repeater).

The tests took place in an outdoor garden over an about 8 week period at temperatures ranging from 2.3 Celsius to 23.5 Celsius (recorded by a nearby weather station) and with a total rainfall of just 20.2 mm. Although the intended service life of each test sensor employed was in excess of 12 months, the test duration was sufficient as a greatly accelerated operation cycle was employed. Sensor and telemetry operation proceeded as in a normal service life, but the sleep period was truncated from around 18 hours to 20 minutes, providing a 40-fold reduction in the overall cycle duration. The sleep state only consumes around 1% of the total power budget even in a normal service life operation, so this reduction in the overall cycle duration did not invalidate an assessment of battery life, as time is counted in cycle equivalents.

A small test network of seven sensors (including the base unit) was operated continuously for around 300 days equivalent (more than 80% of the planned service life) without intervention. The test environment featured a mix of soft and hard landscaping, with areas of lawn and paving, flanked by beds with a variety of plants from small flowers to substantial trees. The whole test site featured a moderate slope, with a substantial change of level between the house/patio/conservatory level and the lawned area leading down to a pergola structure.

The total accumulated testing was over 1800 cycles (over 3 years equivalent) and included both periods of soak testing and shorter investigations of specific features, such as realignment and the various deployment modes. Temperature and humidity variations had little impact on the sensors that were housed within a molded plastic capsule, with evidence of ingress being limited to slight condensation in two units. Battery life was serviceable and was able to power the test sensor and telemetry beyond the proposed service life period. It is expected that a wider range of ambient temperature and humidity than encountered in these tests would degrade battery life somewhat but there appears to be considerable reserve available to cover this. Realignment parameters have been empirically determined as a compromise between robust operation and power consumption (5% duty cycle listening, 5 short search cycles, 3 full search cycles).

The main deployment process has been developed from its initial ‘daisy-chain’ to a form more suited to the ‘any available path’ principle of the network. This particularly important in networks employing repeaters. Service mode deployment has been used extensively. It has been modified to prevent it dragging the timing of the existing network forward if deployment takes place during the LISTEN state. In the test network, some problems still remained with deployment during a COMMUNICATE state but these can readily be resolved by additional checks on the type of packet being received (deployment versus normal data). The use of repeaters will be advantageous in most networks. They have been shown to work reliably, both singly and in multiples, in a variety of situations in the tests. The F-antenna has worked well as a limited vertical projection antenna for the sensor nodes. The F-antenna also was suitable for repeater nodes, but it may not be the best choice for all repeater node configurations or network topologies.

While illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as nonexclusive.

While certain features and embodiments of the invention have been described, other embodiments of the invention will be apparent to those skilled in the art from consideration of the specification and practice of the embodiments of the invention disclosed herein. Although exemplary embodiments have been described with regard to pest detection stations, the present invention may be equally applicable to other environments including, for example, detecting environmental conditions. Further, the steps of the disclosed methods may be modified in any manner, including by reordering steps and/or inserting or deleting steps, without departing from the principles of the invention. It is therefore intended that the specification and examples be considered as exemplary only, with a true scope and spirit of the invention being indicated by the following claims.

What is claimed is:

1. A method for controlling a first node in an ad hoc network including a plurality of network nodes, at least some of which being asynchronous nodes having a dormancy period and a non-dormancy period, the method comprising:
activating a non-dormant-state after a predetermined period of dormancy;
storing status information at the first node, said status information describing at least one condition of the first node;
receiving, during the non-dormant-state, status information about a second, non dormant node;
storing the received status information at the first node;
communicating the stored status information of the first node and the second node; and
reactivating the dormant-state.

2. The method of claim 1, wherein status information includes at least one parameter indicative of a respective condition of at least one of the plurality of network nodes.

3. The method of claim 2, wherein the status information parameter is indicative of at least one of power low, sensor trigger, dormant state, or communication status.

4. The method of claim 3, wherein the status information is represented by a Boolean value indicating whether the condition is true or false.

5. The method of claim 1, wherein the received status information includes status information of a third node.

6. The method of claim 1, further comprising:
modifying the duration of the dormancy period if no information is received from another node.

7. The method of claim 6, wherein modifying the duration of the dormancy period includes substituting a period at the beginning or end of the dormancy period during which the sensor node listens for communication from another node.

8. The method of claim 1, further comprising:
activating a standby state based on the information received from the second node, the standby state being interrupted upon receiving a communication from a handheld node operable by a serviceperson.

9. The method of claim 1, wherein the second network node is a base node that remains in a non-dormant-state and is configured to wirelessly communicate with one or more of the plurality of network nodes and communicate to a remote monitoring unit configured to log status information from one or more of said nodes and to send a notification to a responsible party.

10. The method of claim 1, wherein reactivating the dormant-state comprises:
reactivating the dormant-state after receiving status information of another of the plurality of nodes in the network.

11. The method of claim 10, wherein the dormant-state is reactivated when the received status information includes a parameter indicating that the second network node is entering the dormant-state.

12. The method of claim 1, further comprising:
reactivating the dormant-state after a second predetermined time period if no information is received from another node.

13. The method of claim 1 wherein, when a communication is received from another node, activating the dormant-state includes storing a sleep parameter in the status information of the first node indicating that the node is entering the dormant-state and broadcasting the stored status information of the first node and the second node.

14. The method of claim 1, wherein the status information about a second node is received from a third node spaced apart from a plane of the sensor network, the plane being a surface defined by nodes.

15. The method of claim 1, wherein the status information about a second node is received from a third node spaced above a ground surface.

16. A sensor node configured for use in an asynchronous, ad-hoc network including a plurality of sensor nodes, comprising:
a processor;
a sensor;
a communication unit adapted to broadcast and receive status information about at least one of the plurality of nodes;
wherein the sensor node stores computer-readable instructions that, when executed by said processor, are configured to:
activate a non-dormant-state after a predetermined period of dormancy;
store local status information at the node, said local status information including sensor data measured by the at least one sensor, the sensor data being indicative of a condition of the sensor node;
receive, via the communication unit during the non-dormant-state, status information about at least one other of the plurality of sensor nodes in the network;
store the received status information at the node;
communicate the stored local and received status information; and
reactivate the dormant-state.

17. The sensor node of claim 16, wherein sensor status information is a Boolean value indicating whether a sensor in the node was triggered.

18. The sensor node of claim 16, wherein the received status information includes status information of another of the plurality of nodes.

19. The sensor node of claim 16, wherein the sensor node is further configured to decrease the duration of the dormancy period if no information is received from another node.

20. The sensor node of claim 16, wherein the sensor node is further configured to activate a standby state based on the information received from another node, the standby state being interrupted upon receiving a communication from a handheld node operable by a serviceperson.

21. The sensor node of claim 16, wherein the second network node is a base node that remains in a non-dormant-state.

22. The sensor node of claim 16, wherein the sensor node is further configured to reactivate the dormant-state after receiving status information of other of the plurality of nodes in the network.

23. The sensor node of claim 22, wherein the sensor node is further configured to reactivate the dormant-state when the received status information includes a sleep instruction.

24. The sensor node of claim 16, wherein the sensor node is further configured to reactivate the dormant-state after a second predetermined time period if no information is received from another node.

25. The sensor node of claim 16 wherein, if a communication is received from another node, the sensor node is further configured to store a sleep flag in the status information of the first node and broadcasting the stored status information of the first node and the second node.

26. The sensor node of claim 16, which is installed substantially below a ground surface.

27. The sensor node of claim 26, wherein the communication unit further comprises an antenna which broadcasts status information substantially above the plane of the ground surface.

28. The sensor node of claim 26, wherein the communication unit rebroadcasts the status information over multiple radio frequencies.

29. The sensor node of claim 26, wherein the communication unit rebroadcasts the status information multiple times on the same radio frequency.

30. A method for controlling a termite sensor node in an ad hoc network including a plurality of termite sensor nodes, each node operating asynchronously, the method comprising:
activating a non-dormant-state after a predetermined period of dormancy;
storing detection information at the node, said detection information including a Boolean value indicating whether or not a termite detector in the node has been triggered;
receiving, during the non-dormant-state, detection information about another, non-dormant termite sensor node;
storing the received status information at the node;
communicating the stored detection information of the first node and the at least one other node; and
activating the dormant-state.

31. A monitoring system, comprising:
a base node configured to communicate with one or more sensor nodes over an ad hoc network;
a remote monitoring unit configured to communicate with the base node, to log data from one or more of said sensor nodes, and to send a notification to a responsible party when a Boolean value from one or more of said sensor nodes indicates a trigger condition; and
one or more sensor nodes including at least one sensor configured to measure at least one trigger condition indicative, each of said one or more sensor nodes configured to communicate sensor data including the Boolean value indicative of the trigger obtained when a signal measured by said at least one sensor fails a threshold test, each of said sensor nodes including program instructions that, when executed by a processor in the sensor node, are configured to:
activate a non-dormant-state after a predetermined period of dormancy;
store sensor data at the node, said sensor data describing at least one condition indicative of the trigger condition;
receive, during the non-dormant-state, sensor data about at least one other non-dormant sensor node in the network;
store the received sensor data at the first node;
communicate the stored sensor data of the first node and the second node; and
reactivate the dormant-state.

32. The system of claim 31 in which the base node and the one or more sensor nodes communicate wirelessly.

33. A method for controlling a termite sensor node in an ad hoc network including a plurality of termite sensor nodes, each node operating asynchronously, the method comprising:
activating a non-dormant-state after a predetermined period of dormancy;
storing, at the node, status information indicating whether or not a termite detector in the node has been triggered;
storing, at the node, information indicating whether or not the node has communicated the stored status information to another non-dormant one of the plurality of termite sensor node included in the plurality of nodes;
communicating the stored information; and
reactivating the dormant-state.

34. A method for controlling a node in an ad hoc network including a plurality of network nodes, each node operating asynchronously from the other nodes, the method comprising:
activating a non-dormant-state after a predetermined period of dormancy; and
activating a standby state during a predetermined portion of the dormant-state if no communication is received from another node,
wherein the standby state precedes or succeeds the non-dormant-state and is interrupted upon receipt of a communication from another node.

35. The method of claim 34 wherein, when the standby state is interrupted, the method further comprises:
storing status information describing at least one condition of the node;
receiving status information from another node;
storing the received status information; and
broadcasting the stored status information of the first node and the second node; and
reactivating the dormant-state.

36. A method for servicing a sensor node within an ad hoc network including a plurality of sensor nodes, the method comprising:
activating a non-dormant-state after a predetermined period of dormancy;
receiving status information from a second, non-dormant node during the non-dormant-state; and
activating, based on the status information, a service-state for a predetermined period of time.

37. The method of claim 36, wherein the second node is a base node that remains in a non-dormant-state.

38. The method of claim 36, wherein the second node sends information received from another of the plurality of nodes.

39. The method of claim 36, wherein the information is provided to the network in a second predetermined time period in advance of servicing the network.

40. The method of claim 36, further comprising:
receiving information from a handheld node operated by an serviceperson; and
broadcasting a beacon signal in response to the information received from the third node.

41. The method of claim 40, wherein the handheld node indicates a distance to the first node based on the strength of the beacon signal.

42. The method of claim 41, wherein the node the location of the node is substantially underground and the serviceperson identifies the location of the first node using the handheld node.

43. A scaleable wireless sensor network, comprising:
a plurality of sensor nodes operable to detect at least one pest condition;
at least one local area network using an ad hoc protocol that asynchronously connects said plurality of sensor nodes;
a gateway node wirelessly and asynchronously connected to said at least one wireless local area network configured to log data from one or more of said sensor nodes; and
an operations center operationally connected to said gateway node using a wide area network protocol.

44. A method for installing a sensor network, comprising:
installing a first network node at a first location;
broadcasting a beacon signal from the first network node;
identifying a installation location for a second node based on the quality of the available beacon signal at the identified installation location;
installing the second node at the second location;
retransmitting the beacon node from the first and second nodes;
identifying a installation location for a third node based on the quality of the available beacon signal at the identified installation location; and
installing the third node at the third location,
wherein the locations are determined using a handheld service node.

45. The method of claim 43, wherein the quality of the beacon signal is indicated on another node.

46. The method of claim 43, wherein the quality of the beacon signal is determined from at least one of a value indicative of the strength of the beacon signal and a value indicative of data error rate of the beacon signal.
